(19) United States
(12) Patent Application Publication
(10) Pub. No.: US 2015/0039366 A1
(43) Pub. Date: Feb. 5, 2015

(54) Mobile application for automobile business to manage driver-based transporting of vehicles

(71) Applicant: Mashhur Zarif Haque, Lawrence, KS (US)

(72) Inventor: Mashhur Zarif Haque, Lawrence, KS (US)

(21) Appl. No.: 13/987,495

(22) Filed: Jul. 31, 2013

(51) Int. Cl. G06Q 10/06

(52) U.S. Cl. CPC G06Q 10/063112
USPC 705/7.14

(57) ABSTRACT

A method and system of web hosting platform is provided based on an internet based mobile application that is designed to match individual DRIVER(S) to auto dealers, auction houses, driving transport companies and other businesses and individuals (REQUESTORS) seeking to move automobiles, goods, services, tasks etc. from one location to another. The system has been designed to find, organize, manage DRIVERS and all aspects of the trip on a real time basis and reduce the cost of the existing system.

### TECHNICAL FIELD OF INVENTION

The invention relates to an internet based mobile application that is designed to match individual DRIVER(S) to auto dealers, auction houses, driving transport companies and other businesses and individuals (REQUESTORS) seeking to move automobiles, goods, services, tasks etc. from one location to another. Additionally, the application allows control and management of all aspects of the trip including purchase of trip insurance, real time monitoring, data gathering, expense report preparation, vehicle condition report, real time vehicle location reporting etc.

### BACKGROUND OF THE INVENTION

Automobile businesses need to transport vehicles from one point to another on a regular basis. Examples include transporting individual vehicle to and from locations in and out of auction houses, dealer lots, inspection stations etc. Presently, the REQUESTORS use methods such as making phone calls, or using the services of third parties to find, organize and manage drivers. Existing process of transporting vehicles via these methods is slow, inefficient, difficult to manage, and costly. The present process is fraught with confusions caused by events including but not limited to loss of paper works such as gate passes, vehicle condition reports, and payment receipts by DRIVERS etc. Timely availability of DRIVERS, tracking of vehicles in parking lots and in-transit on real time basis, establishing instant communication with and monitoring and control of DRIVERS by the REQUESTORS are not possible because the communication is carried by phone. The confusion makes the process difficult to manage. Multiple vehicles transported from same origin to same destination with each vehicle being driven by each DRIVER make it necessary for the REQUESTOR to repeat the same instructions to each driver. Repetition of the same instruction multiple times unnecessarily ties up valuable management times of the REQUESTORS making the process slow and inefficient. Real time vehicle sequencing during the auction sales, locating the vehicles in the large auction lots where thousands of vehicles are stationed, managing and monitoring of each auto sales process during auction, and inserting and managing the sales of out of sequence vehicles brought by customers are now carried through verbal, phone communications and CB radios, and many confusions and costly mistakes occur. Overall, the existing process is costly for the REQUESTORS and the DRIVERS alike because (1) the REQUESTORS spend a lot of time in managing the system such as but not limited to giving directions to each DRIVER separately, VIN and Gate Pass information, and special instructions, making phone calls back and forth, (2) of thefts by unscrupulous DRIVERS and others e.g. stolen headrest, missing books, keys, drive shift knobs, (3) DRIVERS do not drive on clock but bill for more hours, (4) third party companies are paid for their services as a middle man, (5) accurate delivery time cannot be determined, (6) DRIVERS are not paid for any lost receipt and (7) of inability to enforce driver accountability during vehicle transporting. Also, reporting by the DRIVERS to reconcile the vehicle condition (e.g. as to dents and scratches) at the auction house exit gate with the condition at the auction bid acceptance time is not easily executed in the existing process. Condition status reports are now communicated verbally by the DRIVERS to the REQUESTORS. This verbal system has many deficiencies such as the REQUESTOR being usually very busy and multitasking may totally forget to record the problem, may assign the problem to wrong vehicle or wrong location in the vehicle. For example, vehicle A in actuality may pull to the right while driving, instead the REQUESTOR may assign the problem to vehicle B as being pulled to the left. Therefore, finding and repairing the problem become costly.

Presently, insurance providers that underwrite insurance policies to the drivers and dealers do not have adequate means to gather appropriate and desirable data that serve the interests of the providers. The underwriters rely on the data what the dealers or insurance agents provide them, do not have any means to verify the accuracy and authenticity of the data and accept the data mainly based on faith. During the application process for purchasing insurance, the purchasers such as dealers, auctioneers, and drivers are asked by the insurance companies to answer the type of questions some of which are listed below: a) How many cars do you estimate that you transport with drivers or Drive-Away? b) Are the driver(s) employee(s) or independent contractor(s)? c) If employee(s), please list driver license number (DL No.), social security no (SSN), date of birth (DOB) etc. d) How far are the trips typically? Please give radius. e) How many of these trips are made within the estimated radius? f) What is the maximum distance of the drive? g) What is the highest value of vehicle you expect to drive?

Most of the Drive-Away drivers are independent who do not have driver employees. Although, these individuals have personal auto insurance, they do not have “commercial” insurance that covers the cars they drive for others when “working”. Dealers take the risk with independent drivers essentially carrying most if not all of the risks by buying insurance policies usually with high deductibles to save on cost of high premiums. Major losses result in high future premiums or cancellation. Of course, the dealers have the choice to hire drivers as their employees which results in higher costs including FICA, taxes, insurance etc.

Presently, insurance policies to cover transporting of vehicles by drivers are underwritten based on bulk volume of vehicles or piggy-backing on other policies, and the policies are based on periodic rates such as daily, monthly, quarterly, yearly etc. Premiums for these types of policies are quite high.

Therefore, what is desired is to develop a system that will be more efficient, faster, easier to manage and less costly. “A Mobile Application for Automobile too Business to Manage Driver-Based Transporting of Vehicles” in accordance with the present invention provides for such a desired system. According to the present invention, a new paradigm is created for the insurance world which is called by-the-trip insurance policy which is different from the in-country or international travel insurance or trip insurance. The new concept is: if a car, X, is transported by a driver, Y, from point, A, to point, B, the insurance policy for this trip consists of the trip from point, A, to point, B, by the driver, Y, and for the time period needed to complete the trip. Once the trip is completed the policy is terminated. The stake holders in this new paradigm of insurance are the dealer (car owner), the driver and the insurance underwriter. The cost of insurance premium in this case could be shared partially by the dealer and the driver through mutually agreeable terms.

### BRIEF SUMMARY OF THE INVENTION

The problems outlined above are in large measure solved by “A Mobile Application for Automobile Business to Manage Driver-Based Transporting of Vehicles” in accordance with the present invention. A method and system are provided to find, contract, organize, and manage DRIVERS and the process of transporting vehicles by the REQUESTOR using internet based communication and management system. The system allows for the purchase of by-the-trip insurance on-the-fly, accurate record keeping of vehicle conditions, record and control of costs, efficient use of DRIVERS by using real time GPS via mobile devices such as cell phones, I pads etc.

More specifically, what is needed is an internet based application that will allow on a real time basis (1) webcasting the need for services of DRIVER(S) by the REQUESTOR whereby the need will be transmitted to the intended DRIVERS or pool of DRIVERS (2) responding to the REQUESTOR by the DRIVERS with their terms and availability (3) accepting the terms of the DRIVERS by the REQUESTOR (4) purchasing by-the-trip insurance on-the-fly 5) executing the vehicle transportation (6) recording and reporting the vehicle status before the vehicle leaves the auction gate (7) reporting and monitoring of the trip status report at any time (8) recording and reporting of expenses and DRIVERS bills and (9) monitoring and controlling of the vehicle transportation process on a real time basis. It must be repeated here that each of the nine functions listed above can be accomplished on a real time basis.

### DETAILED DESCRIPTION OF THE INVENTION

The system consists of a number of functioning modules namely a set of modules for each of the two parties, REQUESTOR (e.g. dealer) and DRIVERS. There is a Sign Up module for each party that will capture some personal information of the party who wants to use the system. To use the system, registering DRIVER will be asked to provide some personal information such as names, address, driving license and auto insurance policy, special need, telephone number, email address etc. that will allow the DRIVER to webcast his/her profile and qualifications to the REQUESTOR. Likewise, the REQUESTOR profile and need are also webcast by the REQUESTOR to the pool of DRIVERS the REQUESTOR wants to reach. Real time need for DRIVERS by the REQUESTOR is communicated to the DRIVERS through the Trip Request Module. This module will show details such as the number of DRIVERS needed, trip origination address, trip destination address, time frame, VIN number, airline ticket, gate pass and special instructions if there is any. The interested DRIVER will then be able to access a module to respond to the REQUESTOR informing about his present GPS location, availability, his rate and preferred method of payment etc. The REQUESTOR will be able to make a contract with the DRIVER to transport a vehicle from one point to the other.

The system will allow for the insurance underwriters to access accurate information before the commencement of the trip for each driver and each car such as the asset data to assess approximate asset value, driver's motor vehicle record (MVR) and background, driver's personal information such as SSN, driver's existing insurance policy, driver's credit report, the number of trips made, average distance of the trip, type of car (VIN, odometer reading, purchase price), dealer's present insurance policy details, dealer's claim history and accident records gathered on a real-time basis to analyze drive-away risk on a real-time basis. The system actually reduces risks for each party, namely insurance underwriters, drivers and the dealers. The premiums could be shared by the drivers and the dealers thus reducing costs for each and spreading the risks. The insurance underwriters would be able to better estimate the premiums because real-time data will be available at their finger tips; and their business will not be based on faith alone. They will have very reliable and real-time data which will facilitate reduction of unscrupulous claims and more accurate assessment of premiums and thereby reduce their risks. The invention comprises an algorithm which calculates insurance premium of by-the-trip insurance policies based on the data mentioned above and considering the ability for real time tracking of the asset during transporting. During the transport process, the DRIVER and the REQUESTOR will be able to communicate with each other on a real time basis to display the location of the vehicle, status report and other information allowing the REQUESTOR to monitor the progress of the trip, estimate the mileage and ensure DRIVER accountability in executing the transport in a manner desirable to REQUESTOR.

A Trip Details Module will allow recording of total miles driven, trip charges, toll, gas, meal and other expenses. The DRIVER will then send a bill at the conclusion of the trip to the REQUESTOR showing details such as the bases of the bill e.g. Flat, Mileage, Hourly and other expenses via the Pay Request Module.

A Super Administrator Module will allow for real time auction lane-vehicle sequencing, management, monitoring and accurate locating of lane vehicle, and sudden inserting of out of sequence automobiles into the auction sales process by the customers.

What is claimed is:

1. A method and system of a mobile application for automobile business to manage driver-based transporting of vehicles comprising:
a Home Screen allowing the user to sign in either as DRIVER or as REQUESTOR (dealer) using User Name and Password
a Sign Up Module for dealer showing dealer type, legal name, DBA, billing address, phone, fax, email, dealer license, home location, authorized users' names, phone numbers, pay preferences to drivers, upload insurance to DRIVERS
a Driver Search Module for REQUESTOR (dealer) showing a Registration window and with means to access a data base of participating DRIVERS showing each DRIVER's name, location, cost rates, number of dealers who use his/her service, age and many other vital information to assist the REQUESTORS to decide if the REQUESTOR would ask for his/her service
a Sign Up Module for DRIVER showing legal name, email, cell phone, home phone, address, SSN, date of birth, driver's license, auto insurance company, auto insurance policy, acceptable payment method, type of trip available for, references, restrictions etc.
a My Request Module for (dealer) webcasting the transport need of the dealer showing pickup, number of vehicles (number of DRIVERS) needed to be picked up, time frame for pickup, distance of travel, pick up point, destination point etc.,
an Acceptance Module for the accepting DRIVERS to webcast the acceptance of My Request to the REQUESTOR
a Purchase Insurance Module that has an algorithm which calculates premiums for by-the-trip policies based on data collected by this invention including driver's motor vehicle record (MVR i.e. driving history, driver's current insurance status, dealer's current insurance status), vehicle condition report, asset value, VIN number, purchase price, total distance of the trip, time required for the trip, vehicle speed, vehicle history report revealed by the VIN report, potential witness of the trip via knowledge of driving team members in the trip and real time tracking, the said algorithm requiring vehicle condition report upload prior to drive to safeguard insurance underwriters from pre-existing damage claims and driver information such as DL No., SSN, credit background, peer-to-peer rating, the said Purchase Insurance Module communicating with all the Modules of this invention to gather data for each driver and car such as the number of trips made, average distance, type of car (VIN, mileage, purchase price), who is driving (SSN, driving record, background) gathered on real time basis to calculate an insurance premium pricing matrix for each party namely the driver's share of the premium, the dealer's share of the premium allowing splitting premium between the driver and the dealer,
a Pick up Details Module instructing the accepting DRIVERS giving details of the trip e.g. origination, destination, stops, VIN of vehicles, time frame, airline pass, special instructions, dealer contact details
a My Driver Module keeps track of all DRIVERS driving for REQUESTOR with real time GPS location data even when DRIVERS are not working (rest period) for the REQUESTOR
an Accounting Module creates a data base for stats such as number of vehicles moved, trips, gas, toll, payroll, taxes, reimbursements, time, locations etc. ensuring driver accountability with real-time monitoring, utilizing gathered data of this invention to facilitate creation of a by-the-trip insurance pricing matrix for the insurance underwriters to offer to the drivers and dealers
A Super Administrator Module will allow for real time auction lane-vehicle sequencing, management, monitoring and accurate locating of lane-vehicle, and sudden inserting of out of sequence automobiles into the auction sales process by the customers a means to push and pull data from other service providers, a means to integrate expense and cost information to current system and a means to invite other DRIVERS into the system as friends.
